(19) United States
(12) Patent Application Publication
(10) Pub. No.: US 2026/0154978 A1
(43) Pub. Date: Jun. 4, 2026

(54) AI-DRIVEN IMAGE FISSION USING LLM TECHNOLOGY

(71) Applicant: eBay Inc., San Jose, CA (US)

(72) Inventors: Shiwam Mittal, Santa Clara, CA (US); Rahul Ajaykumar Agarwal, Santa Clara, CA (US); Hongye Li, Milpitas, CA (US)

(21) Appl. No.: 18/969,014

(22) Filed: Dec. 4, 2024

(51) Int. Cl. G06V 20/70; G06T 11/00

(52) U.S. Cl. CPC G06V 20/70; G06T 11/00

(57) ABSTRACT

Systems and methods are directed decomposing an image using artificial intelligence (AI) and large language model (LLM) technology. The system accesses an image containing one or more objects and processes the image through an image captioning model to generate an image caption for the image. The system then creates an enhanced prompt by integrating the image caption with user inputs that describe or customize the object(s) in the image into a general prompt for a category associated with the image. The enhanced prompt triggers a text-based LLM to decompose the image into individual components and corresponding details. The system then causes presentation of a user interface that includes results from the text-based LLM, whereby the user interface include fields for each individual component.

### TECHNICAL FIELD

The subject matter disclosed herein generally relates to image processing. Specifically, the present disclosure addresses systems and methods that uses artificial intelligence (AI) and large language model (LLM) technology to perform image fission, decomposing an image into individual items or components.

### BACKGROUND

Often, when a user attempts to find items in an image, they are forced to perform multiple searches in order to identify all the items. Furthermore, if the user is interested in making an object in the image, they are often left guessing at what components are needed, a quantity of each component, and where to find all the components. While a large language model (LLM) can be used to decompose an image, it is lacking in context for the image decomposition or fission.

### BRIEF DESCRIPTION OF THE DRAWINGS

FIG. 1 is a diagram illustrating an example network environment suitable for AI-driven image fission using LLM technology, according to example implementations.

FIG. 2 is a diagram illustrating components of an image fission system, according to example implementations.

FIG. 3A-FIG. 3J illustrate an example of AI-driven image fission using LLM technology, according to example implementations.

FIG. 4 is a flowchart illustrating a method for performing AI-driven image fission using LLM technology, according to example implementations.

FIG. 5 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Systems and methods that analyze and decompose images into individual items or components are discussed herein. Example embodiments integrate an image captioning model with a text-based large language models (LLM) to create a seamless process for detailed image analysis and object identification. The combination enhances prompt generation by merging detailed image captions with user inputs, ensuring rich context for the LLM to decompose the images into individual components accurately. Example embodiments produce a detailed result with multiple fields for each identified component, including, for example a quantity and a description. The detailed result can also include assembly instructions tailored to various applications or categories like inventory management and DIY guides. By incorporating user inputs (e.g., user selected options), the results are more personalized, thus improving usability and relevance. Additionally, the user inputs provide additional context to the LLM, thus resulting in a more accurate result.

In example embodiments, the user can create an image that will be decomposed. For example, the user can select one or more objects and customize features of the object(s) (e.g., color, size, material) that result in the image. The image is then applied to an image captioning model to generate an image caption for the image. Image embeddings of the image, user inputs associated with the selection of the object(s) and the customization of features, and the image caption are then combined with a general prompt for a category associated with the object(s) to generate an enhanced prompt. The LLM is then triggered by the enhanced prompt to decompose the image into individual items or components that, in some embodiments, can be used to make/build the object(s).

As a result, example embodiments provide a technical solution to the technical problem of image decomposition. In particular, the technical solution provides additional context to the text-based LLM such that the image can be decomposed accurately. This is done by performing two AI phases. In a first AI phase, an image captioning model generates an image caption for an image. The image caption is then combined with user inputs (e.g., provided to customize features within the image) to generate a description for the image. An enhanced prompt is then generated by incorporating the description into a general prompt for a category associated with the object(s). In a second AI phase, a text-based LLM processes the enhanced prompt to decompose the image into individual items, components, or parts (collectively referred to as “components”).

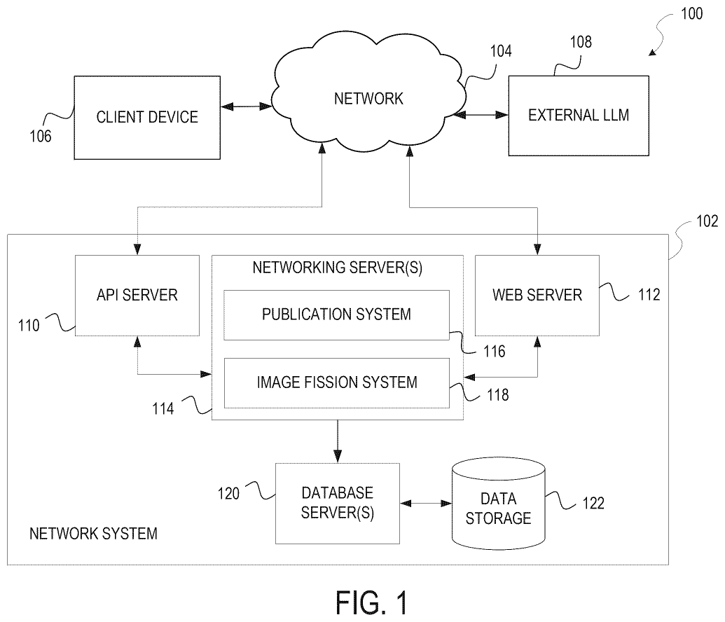

FIG. 1 is a diagram illustrating an example network environment 100 suitable for AI-driven image fission using LLM technology, according to example implementations. A network system 102 provides server-side functionality via a communication network 104 (e.g., the Internet, wireless network, cellular network, or a Wide Area Network (WAN)) to a client device 106. The network system 102 is configured to decompose images into individual items or components and provide details regarding the items or components (e.g., quantity, type, material, price, where to find), as will be discussed in more detail below.

In various cases, the client device 106 is a device associated with a user of the network system 102, such as a customer of an entity that operates the network system 102. For example, the client device 106 can be a device associated with a user that uses the network system 102 to generate or select an image comprising one or more objects and has the image decomposed into individual items or components that the user can obtain. In some cases, the user may decompose the image into components such that the user can do-it-yourself (DIY) to build the object(s) in the image.

The client device 106 may comprise, but is not limited to, a smartphone, a tablet, a laptop, multi-processor systems, microprocessor-based or programmable consumer electronics, a desktop computer, a server, or any other communication device that can access the network system 102. The client device 106 can include an application that exchanges data, via the network 104, with the network system 102. For example, the application can be browser application or a local version of an application associated with the network system 102 that can provide data to and access data from one or more components at the network system 102.

In example implementations, the client device 106 interfaces with the network system 102 via a connection with the network 104. Depending on the form of the client device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

The external LLM 108 is a third-party LLM or generative artificial intelligence (AI) that processes data on behalf of the network system 102 (e.g., GPT4). The LLM is a trained model configured to generate text and perform natural language processing tasks. Generally, the external LLM 108 learns relationships from a large data set during a training process and can then be used to generate text by taking an input and repeatedly predicting a next token or word, for example. In some embodiments, the external LLM 108 decomposes images on behalf of the network system 102 based on an enhanced prompt that is generated by the network system 102, as will be discussed in more detail below. In some embodiments, the external LLM 108 comprises an image captioning model or LLM that can generate image captions, as will also be discussed in more detail below. It is noted that if the network system 102 comprises an internal LLM, then the external LLM 108 is not necessary.

Turning specifically to the network system 102, an application programing interface (API) server 110 and a web server 112 are coupled to and provide programmatic and web interfaces respectively to one or more networking servers 114. The networking servers 114 host various systems including a publication system 116 and an image fission system 118, each comprising a plurality of components and each of which can be embodied as a combination of hardware, software, and/or firmware. The networking servers 114 can comprise other system based on the nature of the network system 102.

The publication system 116 is configured to manage publications (e.g., articles, documents, listings of available goods or services) and transactions at the network system 102 including generating and publishing the publications, conducting searches for publications, and/or maintaining user accounts of users of the network system 102. In example embodiments, the publications can be for components that are identified by the image fission system 118, as will be discussed in more detail below.

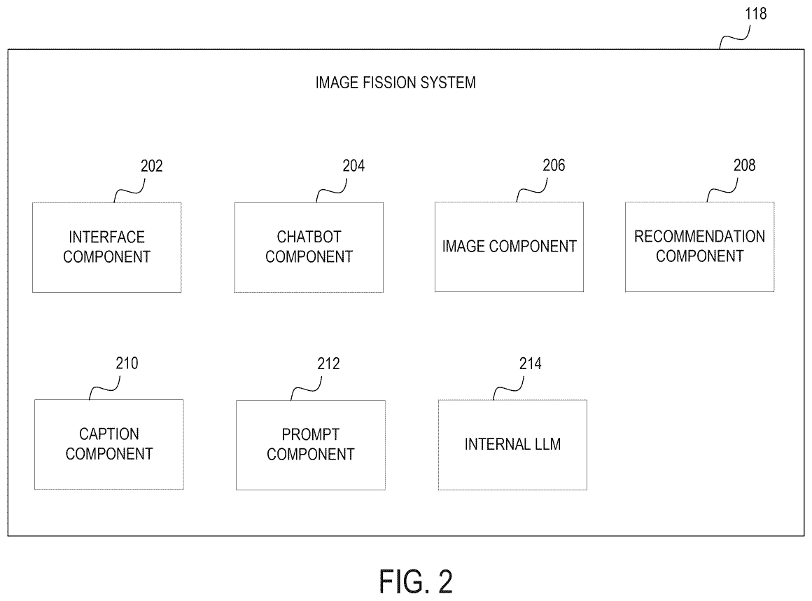

The image fission system 118 is configured to access and/or generate images comprising one or more objects that users select and/or customize and decompose the same images into individual components that make up the objects. In some examples, the individual components allow the user to build the objects in the images and can be obtained from the publication system 116. The image fission system 118 will be discussed in more detail in connection with FIG. 2 below.

The networking servers 114 can be, in turn, coupled to one or more database servers 120 that facilitate access to one or more storage repositories or data storage 122. The data storage 122 is a storage device storing, for example, user accounts including user profiles of users of the network system 102, records of transactions between the users and the network system 102, and user activities with the image fission system 118 (e.g., user selections, generated images).

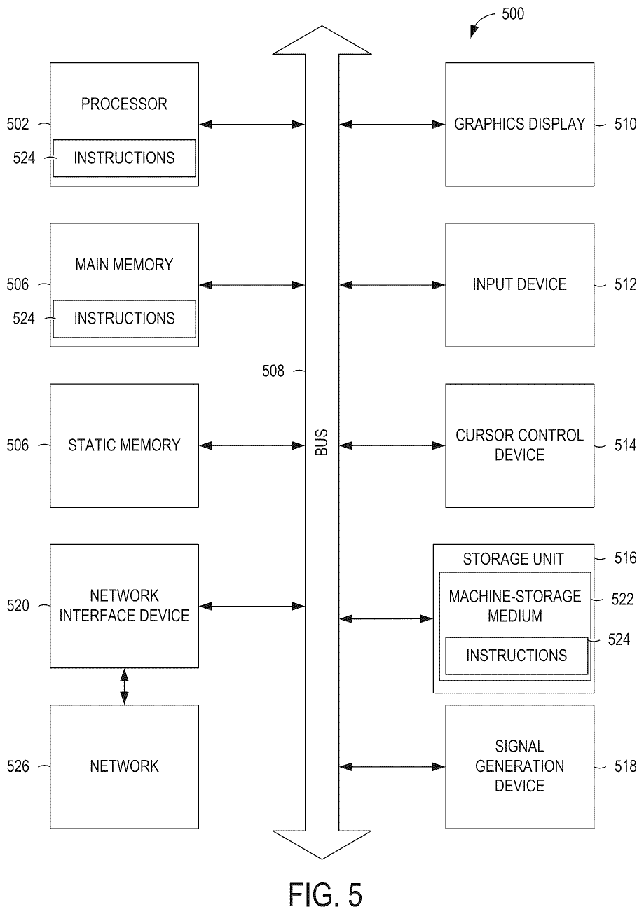

Any of the systems, data storage, servers, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 5, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one component may, in alternative examples, be embodied in a different component. Additionally, any number of client devices 106 and data storage 122 may be embodied within the network environment 100. While only a single network system 102 is shown, alternatively, more than one network system 102 can be included (e.g., localized to a particular region).

FIG. 2 is a diagram illustrating components of the image fission system 118, according to example implementations. In example embodiments, the image fission system 118 comprises a server that manages image creation and decomposition using artificial intelligence (AI) and large language model (LLM) technology. The decomposition can reduce the object(s) in a final image into individual items or down to a granular level of individual components used to create the object(s). To enable these operations, the image fission system 118 comprises an interface component 202, a chatbot component 204, an image component 206, a recommendation component 208, a caption component 210, a prompt component 212, and an internal LLM 214 configured in communication with one another (e.g., via a bus, shared memory, or a switch).

The interface component 202 is configured to exchange data with the client device 106 including managing user interfaces that are displayed on the client device 106. In example embodiments, the interface component 202 can receive inputs via the user interface from the client device 106 and cause presentation of information on the user interface. For example, the interface component 202 can facilitate communication between the client device 106 and a chatbot managed by the chatbot component 204. The communications can include receiving user selection of options that customize the object(s) displayed in images, display of images that are generated based on the user selections of the options, and display of a result of decomposition generated by an LLM (e.g., external LLM 108 or internal LLM 214). In some cases, the interface component 202 receives an uploaded image or a selection of an image that comprises one or more objects that the user is interested in decomposing instead of the user creating the image.

The chatbot component 204 is configured to manage a chatbot conversation between a user of the client device 106 and the network system 102. In example embodiments, the chatbot component 204 receives, via the interface component 202, inputs that include user selections of options determined and presented by the chatbot. The user selections help the image fission system 118 customize the object(s) in the images. The images include intermediate images that are images generated in response to the user selections prior to a final image in which the user has completed customizing the objects. Based on the user input, the chatbot component 204 can trigger the image component 206 to generate an image based on the user input and can obtain one or more recommendations from the recommendation component 208. The chatbot component 204 then causes the interface component 202 to display an image comprising the recommendation.

In some embodiments, the chatbot component 204 uses AI to determine a next question to ask the user when customizing the image. Because the next question may be affected by a previously user input, the chatbot component 204 takes previous user input(s) into consideration when determining the next question to ask. In one embodiment, the chatbot component 204 comprises a trained model (e.g., an LLM) that is trained on previous questions, selectable options, and answers (e.g., user selection of options) for each category. Thus, the chatbot component 204 has context to automatically determine what the next question should be based on questions the user has already answered.

The image component 206 is configured to generate images based on user selections made via the chatbot. In example embodiments, the image component 206 comprises an image model or LLM that has been trained with billions of images on the Internet. As such, the image model or LLM has the ability to generate images from a text prompt. In some cases, the images are merged images of individual objects selected by the user (e.g., via the user inputs). For example, if the user input is for a green couch (e.g., a first object), the image component 206 generates an image of a green couch. Subsequently, the user can provide an input indicating interest in purple pillows (e.g., a second object) to go with the green couch. The image component 206 can generate a composite image that merges the image of the green couch with an image of the purple pillows. In other cases, the images are based on user selections that customize a feature of an object in the image. For example, the image may show a beige couch (e.g., the object) and the user selection indicates to change the color to green. In response, the image component 206 will change the color of the couch to green. In example embodiments, the image component 206 can generate any number of intermediate images (e.g., as the user is customizing the object(s)) and a final image (e.g., image with object(s) that the user has completed customizing).

The recommendation component 208 is configured to search for recommendations based on user inputs received by the chatbot and the images (e.g., image embeddings) generated by the image component 206. In example embodiments, the recommendation component 208 accesses the publication system 116 and performs an image search for one or more publications that match the created image from the image component 206. For example, if the user input is for a green couch, the recommendation component 208 searches for publications or listings that have a green couch that matches the created image of the green couch.

The recommendation component 208 selects one of the matching publications and identifies a link to the matching publication. In one example, the recommendation component 208 selects the matching publication based on ratings of sellers associated with matching publications (e.g., a publication with the highest seller rating). In another example, the matching publication is selected based on price (e.g., a lowest priced publication). In yet a further example, the matching publication is selected based on user preferences such as, for example, preferred sellers, shipping speed, or shipping costs.

In some cases, the recommendation component 208 cannot find an exact match for an image. In some embodiments, the recommendation component 208 comprises a matching threshold. For example, if the matching threshold is 90%, the recommendation component 208 can select a publication that matches 90% of the embeddings of the created image. In other embodiments, the recommendation component 208 does not return a matching publication and the chatbot component 204 can indicate that there is no inventory that exactly matches what the user is looking for, so they can make it themselves.

The caption component 210 is configured to generate an image caption for the image generated by the image component 206 or an uploaded image. In example embodiments, the caption component 210 comprises or uses an image captioning LLM to generate a determined description stored as an image caption. In one example, the LLM comprises the Bootstrapping Language-Image Pre-training 2 (BLIP2) model.

The prompt component 212 is configured to generate an enhanced prompt that triggers the LLM (e.g., the external LLM 108 or internal LLM 214) to decompose the final image. In example embodiments, the prompt component 212 comprises, or has access to, general prompts for various categories. For example, a home furnishing category can have a general prompt for decomposing an image comprising home furnishing object(s), while a fashion category can have a general prompt for decomposing an image comprising one or more fashion items. The general prompt is “customized” into an enhanced prompt for a final image by incorporating the image caption generated by the caption component 210 with any user inputs (e.g., user selections to customize the object(s)) into the general prompt. Specifically, the image caption and the user inputs are combined into a description of the final image. This description is incorporated into a section of the general prompt designated for the description (e.g., a description field). The description provides additional context for the final image which can be used by the LLM. In some embodiments, the enhanced prompt also includes an example of what the output of the response should look like.

The enhanced prompt is transmitted with the image (e.g., image embeddings) to the LLM (e.g., the external LLM 108 or internal LLM 214). The LLM can be a text-based LLM (e.g., GPT-4) tasked with decomposing the image into individual items/components and providing a detailed result. In embodiments where the network system 102 does not comprise the internal LLM 214, the decomposing can be performed by the external LLM 108. However, if the network system 102 includes the internal LLM 214, the internal LLM 214 performs the decomposition and the external LLM 108 is not necessary.

The result of the decomposition includes fields for each of the individual components. The fields can include, for example, material, quantity, and/or price. In some embodiments, the result can also include an assembly guide with instructions to build the object(s) in the final image. The result is provided to the interface component 202, which causes presentation of the result in the user interface on the client device 106.

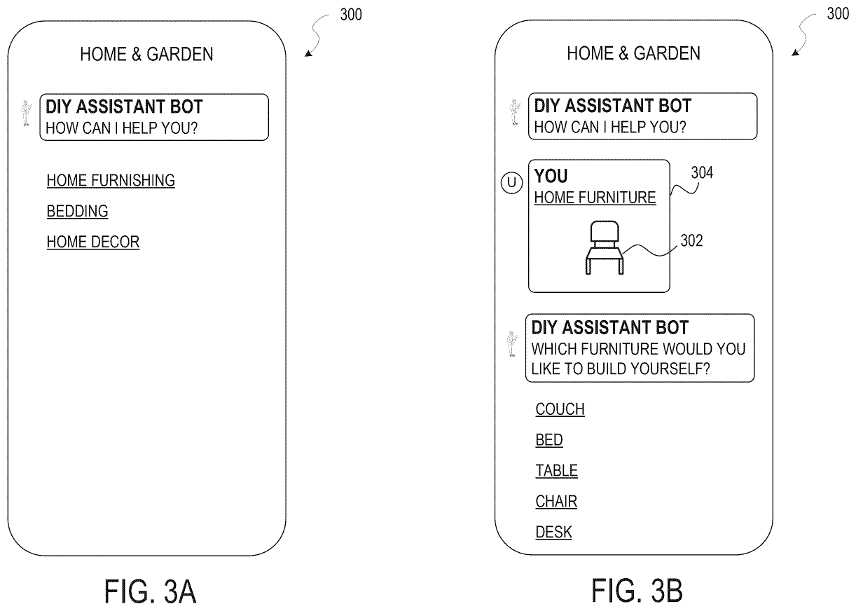

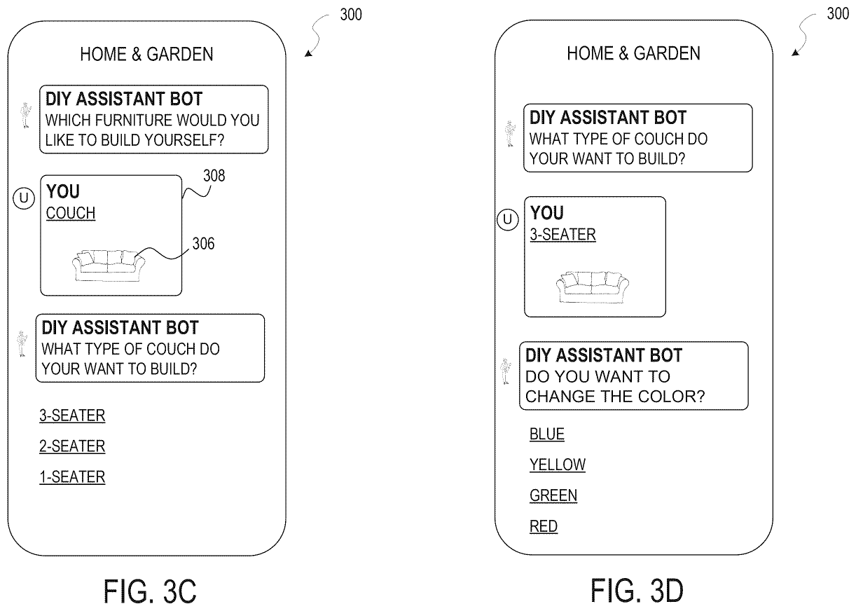

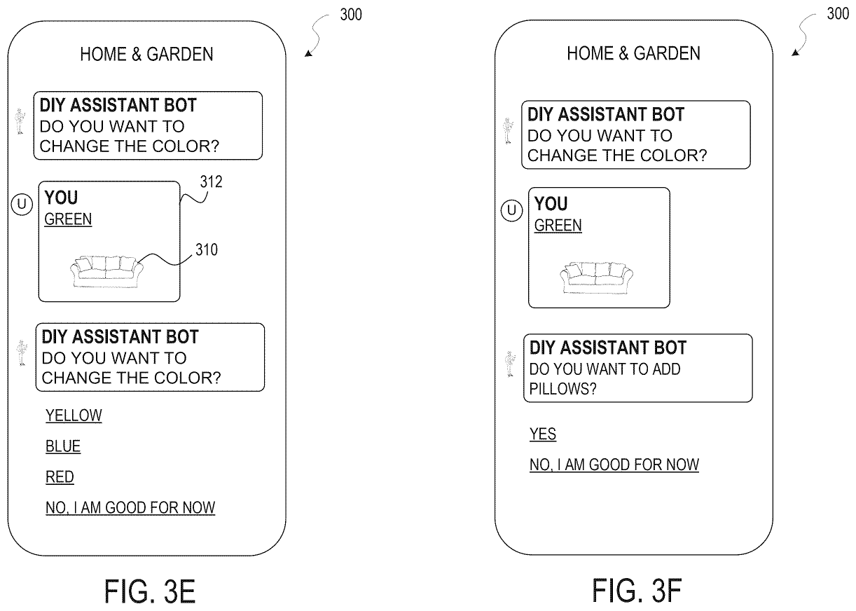

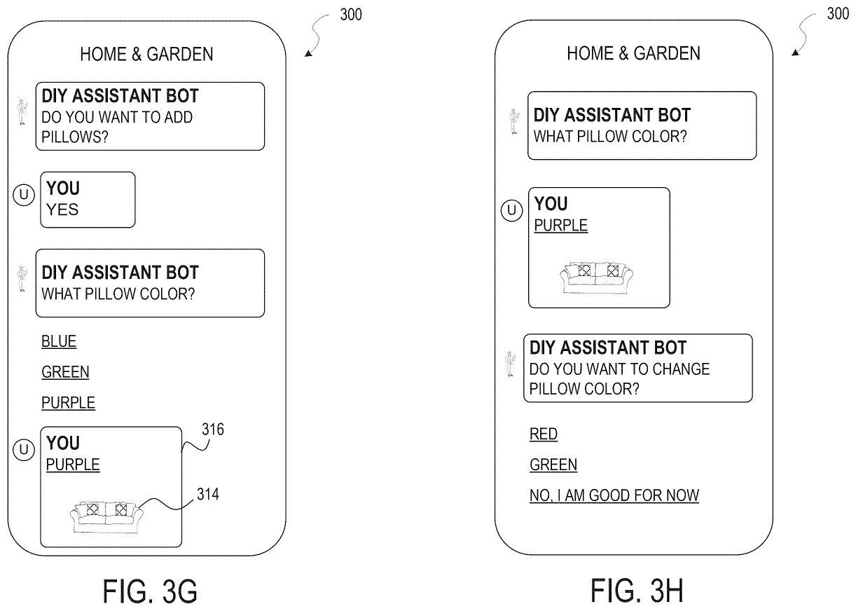

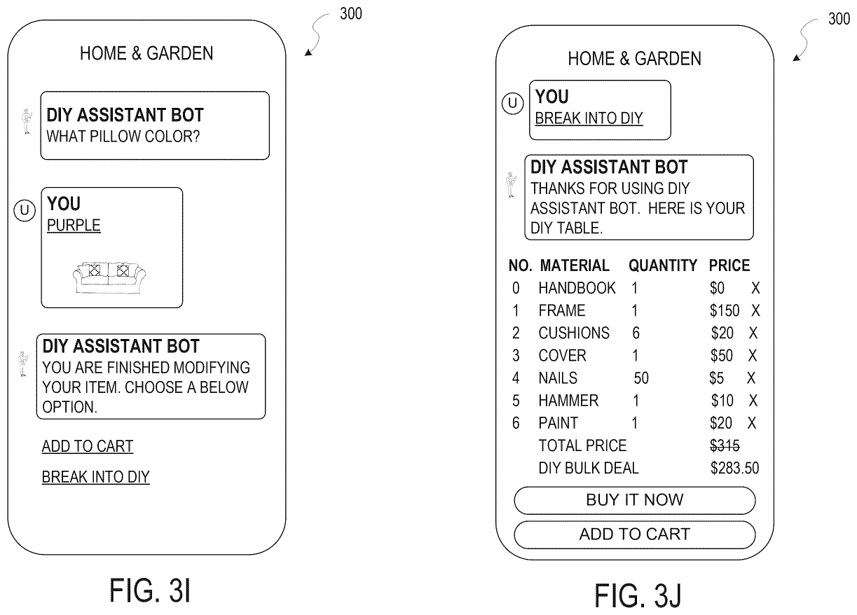

FIG. 3A-FIG. 3J illustrate an example of AI-driven image fission using LLM technology, according to example implementations. The example comprises a chatbot interaction on a user interface 300. A plurality of different categories are available for a user of the client device 106 to select from. Referring to FIG. 3A, the user has selected the Home & Garden category. The chatbot (e.g., the chatbot component 204) initially asks the user how it can help the user. Based on the Home & Garden category, the chatbot presents three further categories (or sub-categories): home furnishing, bedding, and home décor. The user can select one of these categories. In an alternative example, the user can enter a category.

As shown in FIG. 3B, the user has selected the home furnishing category. In response to this selection, the image component 206 generates an intermediate image of a home furnishing object (e.g., a chair) and the recommendation component 208 identifies a matching publication from the publication system 116 that matches the intermediate image. In an alternative embodiment, the recommendation component 208 identifies a matching publication in the home furnishing category from the publication system 116 using a text-based search and retrieves an image from the matching publication. The image 302 (e.g., generated by the image component 206 or retrieved by the recommendation component 208 from the publication) is presented in a user response window 304 along with the selection “Home Furnishing.” In example embodiments, the image comprises a hyperlink to the matching publication. Thus, if the user wants to see more details about the object (e.g., the chair) in the image 302, the user can select the image 302. In some embodiments, the publication is a listing for the sale of the object in the image 302. In an alternative embodiment, the selection of the image 302 can trigger a search for one or more matching publications at the publication system 116.

The chatbot determines a next question and asks the user which furniture they would like to build and provides several options (e.g., couch, bed, table, chair, desk) that the user can scroll through and select from. In some embodiments, the options are determined by the artificial intelligence associated with the chatbot component 204. In other embodiments, the options are known to the chatbot component 204 (e.g., trained with options or retrieves options from a database) and/or can parallel the categories and subcategories used in the publication system 116.

Referring now to FIG. 3C, the user has selected the option for a couch. Based on the selection, the image component 206 generates an intermediate image of a couch (e.g., the object) and the recommendation component 208 identifies a publication from the publication system 116 that matches the intermediate image. Alternatively, the recommendation component 208 can identify a matching publication for a couch from the publication system 116 using a text-based search and retrieves an image of a couch from the matching publication. For example, the recommendation component 208 triggers a search for a couch on the publication system 116 and selects one of the matching publications from the search results. The publication can be selected based on various factors including, for example, seller ratings, price, shipping costs, or speed of delivery or be based on user preferences or past transaction history.

An image 306 of the couch (e.g., generated by the image component 206 or retrieved by the recommendation component 208 from the publication) is presented in a next user response window 308 along with the selection “Couch.” As an example, the image 306 of the couch can show a beige couch. The image 306 can be selected to view the matching publication or trigger a search for one or more matching publications at the publication system 116. The chatbot component 204 determines a next question and set of options to present. In the present example, the next question asks the user what type of couch they would like to build and provides several options (e.g., 3-seater, 2-seater, 1-seater). Once again, these options can be determined by artificial intelligence associated with the chatbot component 204. In other embodiments, the options are known to the chatbot component 204 and/or can parallel the categories and subcategories used in the publication system 116.

FIG. 3D shows that the user has selected the option for a 3-seater couch. Based on the selection, the image component 206 generates a next intermediate image of a 3-seater couch and the recommendation component 208 identifies a publication from the publication system 116 that matches the next intermediate image. Alternatively, the recommendation component 208 can identify a matching publication for a 3-seater couch from the publication system 116 using a text-based search and retrieve an image of a 3-seater couch from the matching publication. It is noted that a publication search can be performed after each user input/selection.

In some embodiments, after each user selection, an undo/reverse button can be provided on the user interface 300 which can be selected to revert to a previous set of instructions (e.g., previous user selection) and previously generated image. For example, if the user selects to undo the selection of the 3-seater, the image fission system 118 can revert to the image of just the couch and ask the user what type of couch they would like. In some embodiments, user activities (e.g., user selections) are stored to the data storage 122. As such, a history of the user activities are maintained and can be reused.

Next, the chatbot component 204 identifies a next question to ask the user. Here, the chatbot component 204 determines that color is an important feature to ask the user about. As such, the chatbot next asks if the user would like to change the color of the couch. Since the image of the couch shows a beige couch, the chatbot component 204 determines other color options and presents them on the user interface (e.g., blue, yellow, green).

Referring now to FIG. 3E, the user has selected the option for the color green. Based on the selection, the image component 206 generates a next intermediate image of a green 3-seater couch and the recommendation component 208 identifies a publication from the publication system 116 that matches the next intermediate image. Alternatively, the recommendation component 208 can identify a matching publication for a green 3-seater couch from the publication system 116 using a text-based search and retrieve an image of a green 3-seater couch from the matching publication. An image 310 of the green 3-seater couch is then presented in a next user response window 312 along with the selection “Green.” As previously, discussed, the image 310 of the green 3-seater couch comprises a hyperlink to the matching publication. Should the user be interested in obtaining more details or purchasing the green couch, the user can select the image to be shown the matching publication. Alternatively, the selection of the image 310 can trigger a search for one or more matching publications at the publication system 116.

Because the user may not like the color choice, the chatbot component 204 can trigger a repeat of the color question. Since the user previously selected green, that option is removed from the option list. The user can select a different color or, if the user is happy with the previous color selection, the user can selection an option indicating that they like the current object (e.g., “No, I am good for now” option). It is noted that the chatbot component 204 can determine other questions to refine the couch selection such as material type (e., velvet, leather, microfiber), style type (e.g., modern, traditional), firmness level, and so forth.

Once the user selects the option indicating that they like the current selection, the couch is finalized and the chatbot component 204 can move on to a next question that does not involve customizing the couch, offer the green 3-seater couch for sale, or present the user with an option to DIY the couch. In the present example, the image fission system 118 determines that pillows might go well with the couch. As such, a next question asks the user if they want to add pillows, as shown in FIG. 3F. Here the user can select to add pillows or select that they are happy with the current couch without pillows. Selection of the option indicating that they are happy can trigger a display to purchase the green couch or DIY the green couch.

If the user selects to add pillows, the chatbot can next ask what color pillows the user would like to add and provide several options (e.g., blue, green, purple) as shown in FIG. 3G. In some examples, the options can be determined by popularity or trend (e.g., most selected on the publication system 116) or be based on user preferences (e.g., favorite colors, color of items purchased in the past). In other examples, the options are known to the chatbot component 204 or just a listing of standard colors.

Here, the user has selected the option for the color purple. Based on the selection, the image component 206 can take the image of the green couch and merges purple pillows into the image to create a merged image (which can also be an intermediate image). Using the merged image, the recommendation component 208 identifies a publication from the publication system 116 that matches the merged image. Alternatively, the recommendation component 208 can identify a matching publication for a green couch with purple pillows from the publication system 116 using a text-based search and retrieve an image of the green couch with purple pillows from the matching publication. An image 314 (e.g., the merged image or the image from the publication) is then presented in a next user response window 316 along with the selection “Purple.” Now if the user selects the image, the user can be shown a single publication having the green couch and purple pillows, the publication associated with the purple pillow, or the publication associated with the green couch. In some embodiments, multiples publications (e.g., one for a green couch and one for purple pillows) can be from a same seller that sells the combination of objects (e.g., the green couch and purple pillow).

Because the user may not be happy with the color choice, the chatbot component 204 can trigger a repeat of the color question for the pillow, as shown in FIG. 3H. Since the user selected purple previously, that option is removed from the option list. The user can select a different color or, if the user is happy with the previous color selection, the user can select an option indicating that they like the current objects (e.g., “No, I am good for now” option). It is noted that other questions can be asked of the pillow such as a quantity of pillows, a size of the pillow, or material type of pillow.

When the user selects the option indicating that they like the current selection, the chatbot component 204 determines if there are any further questions to ask in order to customize the object(s). If there are no further questions to ask, the chatbot component 204 indicates that the user is finished modifying the objects (e.g., “your item”) and can choose an option of either adding the objects from the now final image to their cart or break the objects into DIY components, as shown in FIG. 3I. In some embodiments, a save button can also be provided. Since the user activities can be maintained in the data storage 122, the images (e.g., final image) can be stored and later retrieved should the user want to resume from where they left off.

In the present example, the user selects to break the objects in the final image into DIY components so that they can build the objects themselves. Selecting this option causes the image fission system 118 to apply the final image (e.g., the image of the green couch with purple pillows) to the caption component 210, which generates, using an image captioning model, an image caption for the final image. For example, the image caption can be “a green couch with two purple pillows on it.” The user inputs can include, for example, the type of couch (e.g., 3-seater), which can correspond to a length of the couch (e.g., 33 inches tall, 40 inches deep, and 84 inches wide), a type of fabric for the couch (e.g., velvet, leather), and so forth. This image caption along with the user inputs (e.g., the user selected options) are combined to form a description for the image (e.g., 3-seater green sofa which is 33 inches tall, 40 inches deep and 84 inches wide with two purple pillows).

The description is then combined with a general prompt for the category (e.g., home furnishing general prompt) to generate an enhanced prompt. The general prompt may be the same for all objects in the home furnishings category. Therefore, the general prompt may include aspects or instructions that are not applicable and may be ignored by the LLM 214. The only thing that changes is the description that is added to enhance the general prompt. For example, the general prompt may indicate:
I have an image described as: “{description}”. Please analyze the image, breaking it down into a detailed list of all components required to assemble the object.
Interpret the description in terms of color, material, object type, and dimensions in inches (height×depth×width). The components you list should be sufficient to reassemble the object in the image.
Each component will include the following attributes: quantity, type of material, size in inches (height×depth×width), and a concise 3-word description focusing on its appearance and function, and in which part of the home furnishing this component will fit in 2 words.
Additionally, provide a clear, step-by-step assembly guide, named “Instruction Manual.” If tools are required for assembly, specify them.
The output should be formatted in JSON, with each component and its attributes as part of an array. Example structure:
{{
“components”: [
{{“quantity”: 1, “type_of_material”: “fabric”, “size_in_inches”: {{“height”: 33, “depth”: 40, “width”: 84 }}, “description_in_3_words”: “sofa frame base”}}
]
}}
“″”

The description “3-seater green sofa which is 33 inches tall, 40 inches deep and 84 inches wide with two purple pillows” is merged into a section of the general prompt designated for the description in the first line of the general prompt above (e.g., at the “{description}”) to create the enhanced prompt. Once the enhanced prompt is generated, the enhanced prompt is used to trigger an LLM (e.g., the external LLM 108 or the internal LLM 214) to decompose the final image into components to build the object (e.g., the couch) in the image. It is noted that the LLM will have reference data (e.g., from the web) that a couch will have, for example, four legs. Thus, the LLM has a general knowledge and general context of what it is decomposing. Additionally, the LLM can be trained on global data.

While the above example general prompt indicates word limits for the description of the component (e.g., 3-word description) and an indication of a part of the object that the component fits in (e.g., 2 words), a general prompt can comprise any number word limit up to a total number of tokens the LLM can use (e.g., 128000 tokens for GPT 4). A general prompt can also comprise different, additional, or less description terms or attributes than the example general prompt shown above. Further still, the output can be in a format other than JSON.

An example of the output of the above prompt can be:
Image Description: a green sofa with purple pillows on it
Description: 3 seater green sofa which is 33 inches tall, 40 inches deep and 84 inches wide
Assembly Instructions: {
“components”: [
{
“quantity”: 1,
“type_of_material”: “wood”,
“size_in_inches”: {
“height”: 33,
“depth”: 40,
“width”: 84
},
“description_in_3_words”: “large wooden frame”,
“part_of_couch”: “sofa base”
},
{
“quantity”: 3,
“type_of_material”: “foam”,
“size_in_inches”: {
“height”: 8,
“depth”: 40,
“width”: 28
},
“description_in_3_words”: “soft cushion filling”,
“part_of_couch”: “seat cushion”
},
{
“quantity”: 3,
“type_of_material”: “green fabric”,
“size_in_inches”: {
“height”: 8,
“depth”: 40,
“width”: 28
},
“description_in_3_words”: “green cushion cover”,
“part_of_couch”: “seat cushion”
},
{
“quantity”: 4,
“type_of_material”: “wood”,
“size_in_inches”: {
“height”: 25,
“depth”: 3,
“width”: 3
},
“description_in_3_words”: “sturdy wooden legs”,
“part_of_couch”: “sofa base”
},
{
“quantity”: 1,
“type_of_material”: “green fabric”,
“size_in_inches”: {
“height”: 25,
“depth”: 40,
“width”: 84
},
“description_in_3_words”: “green sofa cover”,
“part_of_couch”: “sofa exterior”
}
],
“Instruction Manual”: {
“step_1”: “Attach the wooden legs to the bottom of the wooden frame.”,
“step_2”: “Place the foam cushions onto the wooden frame.”,
“step_3”: “Cover the foam cushions with the green fabric cushion covers.”,
“step_4”: “Cover the wooden frame, including the cushions, with the green sofa cover.”,
“tools_required”: “Screwdriver and staple gun.”
}
}

The above output is formatted by the chatbot component 204 into a DIY table similar to that shown in the example of FIG. 3J (e.g., the DIY table being the results of the processing of the enhanced prompt). The DIY table can include rows of fields for each component (e.g., cushions, nails) that can comprise a description of the material (e.g., name of component), a quantity (e.g., 50 nails), a price, and/or what the component is for. In some embodiments, all of the components can be obtained from the publication system 116. The recommendation component 208 can, in some embodiments, find a matching publication for each component. As a result, each of the components listed on the DIY table can have a corresponding hyperlink to the publication at the publication system 116 for each respective component. Alternatively, selection of a component can trigger a search for one or more matching publications at the publication system 116. Also included in the DIY table is a handbook/guide that provides instructions or guidance on how to assemble the components. Generation of the handbook is included in the prompt, thus triggering the LLM to generate the handbook.

At this stage, the user can select to buy all the components listed in the DIY table (e.g., Buy It Now or Add to Cart). Because it is not likely that a single seller will sell all of the components, example embodiments can offer a discount (e.g., bulk savings) if the user adds everything to their cart.

It is noted that while the DIY table only comprises components to build the couch, the DIY table can also include fields for the purple pillows (e.g., description of the material is purple pillow; quantity is two; price is $20/each). Alternatively, the DIY table can include fields for components needed to create the purple pillows (e.g., pillow form, pillow covering).

Thus, given an image with one or more objects, example embodiments decomposes the image to a level where the user can buy components to create the one or more objects in the image. In some embodiments, the components can be broken down even further by selecting a DIY option in one of the rows in the DIY table. For example, if the image comprises a woman wearing a blue top, black pants, a watch, and a black leather purse, the prompt may instruct the LLM to decompose the image into individual items/components. As such, the image fission system 118 can generate a DIY table comprising four items: a blue top, a black pair of pants, a watch, and a black leather purse. If the user wants to create one of these items (e.g., the purse), the user can select a further DIY option associated with the item, and the image fission system 118 will further decompose the item into a lower granular level. Now the DIY table for the purse, for example, can indicate components of a zipper, black leather, stitching material, and a strap along with a quantity of each of these components. Each DIY table comprises a DIY kit that includes links to a matching publication for each component and an option to purchase all the components in the DIY kit. It is noted that in an alternative embodiment, selecting one of the components on the DIY table can trigger a search for one or more matching publications at the publication system 116.

While the above example discusses a commerce embodiment to build or DIY an object in an image, example embodiments can be used for other purposes. For example, a user can create, select, or upload an image of a salad. The user can provide user inputs such as, for example, serving size is a bowl and protein is chicken. The caption component 210 can process the image through an image captioning model which generates an image caption of “chicken salad with avocado, blueberries, and strawberries.” Here the description can be “a bowl of chicken salad with avocado, blueberries, and strawberries” whereby “bowl” provides context of a size of the salad.

The prompt component 212 then generates an enhanced prompt by combining the description with a general prompt for food decomposition. The general prompt can be, for example:
I have an image of food described as: “{description}”. Please analyze the image, breaking it down into a detailed list of all components required to
prepare the meal.
Interpret the description in terms of ingredients name, quantity, calories, nutrition facts, cooking method. Ingredients you list should be sufficient to prepare the meal in the image.
Each ingredient will include the following attributes: name, quantity, calories, nutrition facts, and a concise 3-word description focusing on cooking method of the ingredients. Also add any dressings, seasonings if needed.

The output from the LLM can be the following:
Image Description: chicken salad with avocado, blueberries and strawberries
Description: a bowl of chicken salad with avocado, blueberries and strawberries
Assembly Instructions: Based on the image description, here are the components required to prepare the meal:
1. Ingredient: Chicken
Quantity: 1 cup
Calories: 335
Nutrition Facts: High in protein, vitamin B6, niacin, and selenium.
Cooking Method: Grilled, diced.
2. Ingredient: Avocado
Quantity: Half
Calories: 120
Nutrition Facts: Rich in healthy fats, fiber, and vitamins C, E, K, and B-6.
Cooking Method: Fresh, sliced.
3. Ingredient: Blueberries
Quantity: ½ cup
Calories: 42
Nutrition Facts: High in antioxidants, fiber, and vitamin C.
Cooking Method: Fresh, whole.
4. Ingredient: Strawberries
Quantity: ½ cup
Calories: 24
Nutrition Facts: High in antioxidants, fiber, and vitamin C.
Cooking Method: Fresh, sliced.
5. Ingredient: Lettuce
Quantity: 2 cups
Calories: 10
Nutrition Facts: Good source of vitamins A and K.
Cooking Method: Fresh, torn.
6. Ingredient: Salad Dressing
Quantity: 2 tablespoons
Calories: 145
Nutrition Facts: Calorie content can vary greatly depending on the type of dressing. Most dressings contain some amount of sodium.
Cooking Method: Drizzled.
7. Ingredient: Salt
Quantity: To taste
Calories: 0
Nutrition Facts: Essential for maintaining electrolyte balance in the body.
Cooking Method: Sprinkled.
8. Ingredient: Pepper
Quantity: To taste
Calories: 1 per dash
Nutrition Facts: Contains a small amount of vitamin K.
Cooking Method: Sprinkled.
Please note that the calories and nutrition facts can vary depending on the specific brand and type of each ingredient used. The quantities listed here should give you a basic chicken salad with avocado, blueberries, and strawberries. Adjust quantities as needed to suit your personal taste.

It is noted that not all aspects of a general prompt can be applicable for an image. For example, a general prompt for fashion can be:
I have an image described as: “{description}”. Please analyze the image and list all the materials and tools needed to create this outfit. Include fabric types, color, shades, tie, rings, threads, zippers or buttons, pattern paper, watch, handbags, purses, cap, scarf, footwear, measuring tape, sewing machine or needle, and any other necessary items.
Give me quantity of each item in the response. Each item in the response will have following attributes-quantity, type of material, description in 3 words.
Also provide step-by-step guide for it and name that guide as “Instruction Manual”. Provide output in JSON format.

If the above fashion prompt is used to decompose an image of a man in a suit, aspects such as handbags, purses, cap, and scarf are not applicable. Similarly, if the above fashion prompt is used to decompose an image of a woman wearing a dress, aspects such as tie and cap may not be applicable. In these instances, the LLM can ignore those aspects or instructions.

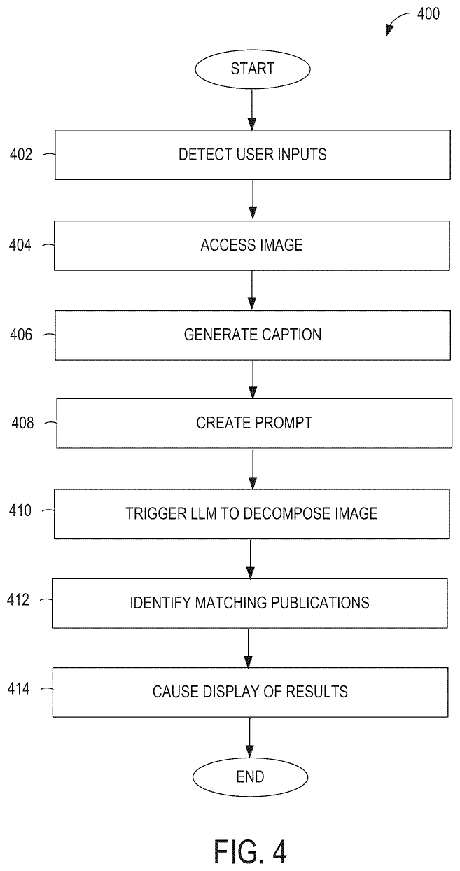

FIG. 4 is a flowchart illustrating a method 400 for performing AI-driven image fission using LLM technology, according to example implementations. Operations in the method 400 may be performed by the image fission system 118, using components described above in part with respect to FIG. 2. Accordingly, the method 400 is described by way of example with reference to the image fission system 118. However, it shall be appreciated that at least some of the operations of the method 400 may be deployed on various other hardware configurations or be performed by similar components residing elsewhere in the network environment 100. Therefore, the method 400 is not intended to be limited to the image fission system 118.

In operation 402, the user interface component 202 detects user inputs. In example embodiments, the user inputs are via a user interface and/or a chatbot. In some cases, the user input can be an upload or selection of an image that the user wants decomposed and/or can include an indication of options associated with the image or options for customizing features of object(s) in the image. In some cases, the user input comprises user selection of options presented by a chatbot.

In operation 404, the caption component 210 accesses the image to be decomposed. In some cases, the image is created by the image component 206 based on user selection of the options presented, for example, by the chatbot component 204. In other cases, the image is uploaded or selected by the user. The image comprises one or more objects which the user wants to decompose into the individual items or components needed to create the one or more objects.

In operation 406, the caption component 210 generates an image caption based on the image accessed in operation 404. In example embodiments, the caption component 210 comprises or uses an image captioning model to generate a description of the image that is stored as the image caption. The image caption is then passed to the prompt component 212.

In operation 408, the prompt component 212 creates an enhanced prompt. In example embodiments, the prompt component 212 access a general prompt for a category associated with the image. For example, if the image is for a home furnishing category, the prompt component 212 accesses the home furnishing general prompt. The prompt component combines the image caption and the user inputs into a description of the image. This description is then incorporated into the general prompt, by the prompt component 212, to generate the enhanced prompt. By including the description, additional context that is specific to the image is provided to the LLM.

In operation 410, the prompt component 212 triggers the LLM to decompose the image. Accordingly, the prompt component 212 transmits the enhanced prompt with the image (e.g., image embeddings) to the LLM, which cause the LLM to decompose the image (e.g., one or more objects in the image) into smaller components. In some cases, the smaller components comprise the individual objects within an image having multiple objects. In other cases, the smaller component comprises components or parts that are needed to build/create the object(s) in the image.

In operation 412, the recommendation component 208 identifies matching publications of the components identified by the LLM. In example embodiments, the recommendation component 208 receives the results from the LLM and searches for one or more matching publications for each component in the publication system 116. The recommendation component 208 can select a matching publication for each component and provides a link to each matching publication to the interface component 202.

In operation 414, the interface component 202 causes display of the results. In some embodiments, the results are displayed in a table (e.g., a DIY table) that comprises fields for each component. The fields include a description/name of the component and a quantity of the component. In some cases, the fields can also into a price for the component. The description/name in the table can be a hyperlink (e.g., based on the link provided by the recommendation component 208) that, when selected, shows the matching publication associated with the selected description/name. The publication can provide additional details regarding the component. In example embodiments, the table also comprises a handbook or instruction manual that provides instructions on how to assemble, create, or build the object(s) in the image.

FIG. 5 illustrates components of a machine 500, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 5 shows a diagrammatic representation of the machine 500 in the example form of a computer device (e.g., a computer) and within which instructions 524 (e.g., software, a program, an application, an applet, an app, or other executable code) for causing the machine 500 to perform any one or more of the methodologies discussed herein may be executed, in whole or in part.

For example, the instructions 524 may cause the machine 500 to execute the flow diagram of FIG. 4. In one implementation, the instructions 524 can transform the machine 500 into a particular machine (e.g., specially configured machine) programmed to carry out the described and illustrated functions in the manner described.

In alternative implementations, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524 (sequentially or otherwise) that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more components described herein.

The machine 500 may further include a graphics display 510 (e.g., a plasma display panel (PDP), a light emitting diode (LED) display, a liquid crystal display (LCD), a projector, or a cathode ray tube (CRT), or any other display capable of displaying graphics or video). The machine 500 may also include an input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a sound card, an amplifier, a speaker, a headphone jack, or any suitable combination thereof), and a network interface device 520.

The storage unit 516 includes a machine-storage medium 522 (e.g., a tangible machine-storage medium) on which is stored the instructions 524 (e.g., software) embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered as machine-storage media (e.g., tangible and non-transitory machine-storage media). The instructions 524 may be transmitted or received over a network 526 via the network interface device 520.

In some example implementations, the machine 500 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 504, 506, and/or memory of the processor(s) 502) and/or storage unit 516 may store one or more sets of instructions and data structures (e.g., software) 524 embodying or utilized by any one or more of the methodologies or functions described herein. These instructions, when executed by processor(s) 502 cause various operations to implement the disclosed implementations.

As used herein, the terms “machine-storage medium,” “device-storage medium,” “computer-storage medium” (referred to collectively as “machine-storage medium 522”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 522 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 522 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 524 may further be transmitted or received over a communications network 526 using a transmission medium via the network interface device 520 and utilizing any one of a number of well-known transfer protocols (e.g., HTTP). Examples of communication networks 526 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 524 for execution by the machine 500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### EXAMPLES

Example 1 is a method for image fission using LLM technology. The method comprises accessing an image containing one or more objects; processing the image through an image captioning model to generate an image caption for the image; creating an enhanced prompt by integrating the image caption with user inputs associated with the image into a general prompt for a category associated with the image; using the enhanced prompt, triggering a text-based large language model (LLM) to decompose the image into individual components and corresponding details; and causing presentation of a user interface that includes results from the text-based LLM, the user interface including fields for each individual component.

In example 2, the subject matter of example 1 can optionally include receiving an indication to decompose an individual component of the results; processing an image of the individual component through the image captioning model to generate an image caption for the image of the individual component; creating a second enhanced prompt by integrating the image caption for the image of the individual component with any user inputs associated with the image of the individual component; processing the second enhanced prompt through the text-based LLM to decompose the image of the individual component into further components and further corresponding details; and causing presentation of results of the processing of the second enhanced prompt.

In example 3, the subject matter of any of examples 1-2 can optionally include wherein the user inputs comprises user selections of options for the one or more objects; and the method further comprises generating the image containing the one or more objects based on the user selection of the options.

In example 4, the subject matter of any of examples 1-3 can optionally include wherein the user inputs are made via a chatbot conversation.

In example 5, the subject matter of any of examples 1-4 can optionally include performing a search for a matching publication based on each of at least some of the user selections of the options; and providing a hyperlink to the matching publication.

In example 6, the subject matter of any of examples 1-5 can optionally include generating a kit comprising the individual components, the kit including a link to a publication associated with each of the individual components and a guide for assembly.

In example 7, the subject matter of any of examples 1-6 can optionally include wherein the enhanced prompt includes instructions to analyze the image and provide a detailed list of materials and tools needed for assembly of the one or more objects in the image; the individual items comprise the materials and tools; and the fields for each individual component comprise a description of the individual component and a quantity.

In example 8, the subject matter of any of examples 1-7 can optionally include wherein the enhanced prompt includes instructions to analyze the image and provide a guide for assembly of the one or more objects in the image; and the results comprise the guide for assembly.

In example 9, the subject matter of any of examples 1-8 can optionally include wherein integrating the image caption with the user inputs received regarding the image into the general prompt comprises generating a description based on the image caption and the user inputs; and incorporating the description into a section of the general prompt designated for the description.

In example 10, the subject matter of any of examples 1-9 can optionally include receiving the results from the text-based LLM; searching for a matching publication for each of the individual components; and providing a link to each of the matching publications for each of the individual components on the user interface.

Example 11 is a system for image fission using LLM technology. The system comprises one or more processors and a memory storing instructions that, when executed by the one or more processors, cause the one or more processors to perform operations comprising accessing an image containing one or more objects; processing the image through an image captioning model to generate an image caption for the image; creating an enhanced prompt by integrating the image caption with user inputs associated with the image into a general prompt for a category associated with the image; using the enhanced prompt, triggering a text-based large language model (LLM) to decompose the image into individual components and corresponding details; and causing presentation of a user interface that includes results from the text-based LLM, the user interface including fields for each individual component.

In example 12, the subject matter of example 11 can optionally include wherein the operations further comprise receiving an indication to decompose an individual component of the results; processing an image of the individual component through the image captioning model to generate an image caption for the image of the individual component; creating a second enhanced prompt by integrating the image caption for the image of the individual component with any user inputs associated with the image of the individual component; processing the second enhanced prompt through the text-based LLM to decompose the image of the individual component into further components and further corresponding details; and causing presentation of results of the processing of the second enhanced prompt.

In example 13, the subject matter of any of examples 11-12 can optionally include wherein the user inputs comprises user selections of options for the one or more objects; and the operations further comprise generating the image containing the one or more objects based on the user selection of the options.

In example 14, the subject matter of any of examples 11-13 can optionally include wherein the operations further comprise performing a search for a matching publication based on each of at least some of the user selections of the options; and providing a hyperlink to the matching publication.

In example 15, the subject matter of any of examples 11-14 can optionally include wherein the operations further comprise generating a kit comprising the individual components, the kit including a link to a publication associated with each of the individual components and a guide for assembly.

In example 16, the subject matter of any of examples 11-15 can optionally include wherein the enhanced prompt includes instructions to analyze the image and provide a detailed list of materials and tools needed for assembly of the one or more objects in the image; the individual components comprise the materials and tools; and the fields for each individual component comprise a description of the individual component and a quantity.

In example 17, the subject matter of any of examples 11-16 can optionally include wherein the enhanced prompt includes instructions to analyze the image and provide a guide for assembly of the one or more objects in the image; and the results comprise the guide for assembly.

In example 18, the subject matter of any of examples 11-17 can optionally include wherein integrating the image caption with the user inputs received regarding the image into the general prompt comprises generating a description based on the image caption and the user inputs; and incorporating the description into a section of the general prompt designated for the description.

In example 19, the subject matter of any of examples 11-18 can optionally include wherein the operations further comprise receiving the results from the text-based LLM; searching for a matching publication for each of the individual components; and providing a link to each of the matching publications for each of the individual components on the user interface.

Example 20 is a machine-storage medium comprising instructions which, when executed by one or more processors of a machine, cause the machine to perform operations for image fission using LLM technology. The operations comprise accessing an image containing one or more objects; processing the image through an image captioning model to generate an image caption for the image; creating an enhanced prompt by integrating the image caption with user inputs associated with the image into a general prompt for a category associated with the image; using the enhanced prompt, triggering a text-based large language model (LLM) to decompose the image into individual components and corresponding details; and causing presentation of a user interface that includes results from the text-based LLM, the user interface including fields for each individual component.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
accessing an image containing one or more objects;
processing the image through an image captioning model to generate an image caption for the image;
creating an enhanced prompt by integrating the image caption with user inputs associated with the image into a general prompt for a category associated with the image;
using the enhanced prompt, triggering a text-based large language model (LLM) to decompose the image into individual components and corresponding details; and
causing presentation of a user interface that includes results from the text-based LLM, the user interface including fields for each individual component.

2. The method of claim 1, further comprising:
receiving an indication to decompose an individual component of the results;
processing an image of the individual component through the image captioning model to generate an image caption for the image of the individual component;
creating a second enhanced prompt by integrating the image caption for the image of the individual component with any user inputs associated with the image of the individual component;
processing the second enhanced prompt through the text-based LLM to decompose the image of the individual component into further components and further corresponding details; and
causing presentation of results of the processing of the second enhanced prompt.

3. The method of claim 1, wherein:
the user inputs comprise user selections of options for the one or more objects; and
the method further comprises generating the image containing the one or more objects based on the user selections of the options.

4. The method of claim 3, wherein the user inputs are made via a chatbot conversation.

5. The method of claim 3, further comprising:
performing a search for a matching publication based on each of at least some of the user selections of the options; and
providing a hyperlink to the matching publication.

6. The method of claim 1, further comprising:
generating a kit comprising the individual components, the kit including a link to a publication associated with each of the individual components and a guide for assembly.

7. The method of claim 1, wherein:
the enhanced prompt includes instructions to analyze the image and provide a detailed list of materials and tools needed for assembly of the one or more objects in the image;
the individual components comprise the materials and tools; and
the fields for each individual component comprise a description of the individual component and a quantity.

8. The method of claim 1, wherein:
the enhanced prompt includes instructions to analyze the image and provide a guide for assembly of the one or more objects in the image; and
the results comprise the guide for assembly.

9. The method of claim 1, wherein integrating the image caption with the user inputs received regarding the image into the general prompt comprises:
generating a description based on the image caption and the user inputs; and
incorporating the description into a section of the general prompt designated for the description.

10. The method of claim 1, further comprising:
receiving the results from the text-based LLM;
searching for a matching publication for each of the individual components; and
providing a link to each of the matching publications for each of the individual components on the user interface.

11. A system comprising:
one or more processors; and
a memory storing instructions that, when executed by the one or more processors, cause the one or more processors to perform operations comprising:
accessing an image containing one or more objects;
processing the image through an image captioning model to generate an image caption for the image;
creating an enhanced prompt by integrating the image caption with user inputs associated with the image into a general prompt for a category associated with the image;
using the enhanced prompt, triggering a text-based large language model (LLM) to decompose the image into individual components and corresponding details; and
causing presentation of a user interface that includes results from the text-based LLM, the user interface including fields for each individual component.

12. The system of claim 11, wherein the operations further comprise:
receiving an indication to decompose an individual component of the results;
processing an image of the individual component through the image captioning model to generate an image caption for the image of the individual component;
creating a second enhanced prompt by integrating the image caption for the image of the individual component with any user inputs associated with the image of the individual component;
processing the second enhanced prompt through the text-based LLM to decompose the image of the individual component into further components and further corresponding details; and
causing presentation of results of the processing of the second enhanced prompt.

13. The system of claim 11, wherein:
the user inputs comprise user selections of options for the one or more objects; and
the operations further comprise generating the image containing the one or more objects based on the user selections of the options.

14. The system of claim 13, wherein the operations further comprise:
performing a search for a matching publication based on each of at least some of the user selections of the options; and
providing a hyperlink to the matching publication.

15. The system of claim 11, wherein the operations further comprise:
generating a kit comprising the individual components, the kit including a link to a publication associated with each of the individual components and a guide for assembly.

16. The system of claim 11, wherein:
the enhanced prompt includes instructions to analyze the image and provide a detailed list of materials and tools needed for assembly of the one or more objects in the image;
the individual components comprise the materials and tools; and
the fields for each individual components comprise a description of the individual component and a quantity.

17. The system of claim 11, wherein:
the enhanced prompt includes instructions to analyze the image and provide a guide for assembly of the one or more objects in the image; and
the results comprise the guide for assembly.

18. The system of claim 11, wherein integrating the image caption with the user inputs received regarding the image into the general prompt comprises:
generating a description based on the image caption and the user inputs; and
incorporating the description into a section of the general prompt designated for the description.

19. The system of claim 11, wherein the operations further comprise:
receiving the results from the text-based LLM;
searching for a matching publication for each of the individual components; and
providing a link to each of the matching publications for each of the individual components on the user interface.

20. A machine-storage medium comprising instructions which, when executed by one or more processors of a machine, cause the machine to perform operations comprising:
accessing an image containing one or more objects;
processing the image through an image captioning model to generate an image caption for the image;
creating an enhanced prompt by integrating the image caption with user inputs associated with the image into a general prompt for a category associated with the image;
using the enhanced prompt, triggering a text-based large language model (LLM) to decompose the image into individual components and corresponding details; and
causing presentation of a user interface that includes results from the text-based LLM, the user interface including fields for each individual component.
